(19) United States
(12) Patent Application Publication
(10) Pub. No.: US 2007/0260654 A1
(43) Pub. Date: Nov. 8, 2007

(54) GARBAGE COLLECTION SENSITIVE LOAD BALANCING

(75) Inventors: Thomas E. Creamer, Boca Raton, FL (US); Curtis E. Hrischuk, Holly Springs, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/382,069

(22) Filed: May 8, 2006

(51) Int. Cl. G06F 17/30

(52) U.S. Cl. 707/206

(57) ABSTRACT

Embodiments of the present invention address deficiencies of the art in respect to load balancing in an enterprise environment and provide a method, system and computer program product for garbage collection sensitive load balancing. In a first embodiment of the invention, a load balancing method can include selectively avoiding server resources experiencing garbage collection when routing workloads to server resources in a load balanced cluster of server resources. For example, selectively avoiding server resources experiencing garbage collection when routing workloads to server resources in a load balanced cluster of server resources, can include detecting a garbage collection operation in a particular server resource, and avoiding routing of a workload to the particular server resource until the garbage collection operation has completed.

### BACKGROUND OF THE INVENTION

1. Field of the Invention

The present invention relates to the field of distributed computing and more particularly to the field of load balancing processing requests in a distributed computing environment.

2. Description of the Related Art

In the typical distributed system, content or logic services can be delivered from one or more origin servers to a community of consuming clients. Services and content typically can be delivered according to a request-response paradigm in which the consuming clients initiate a request for services to which one or more origin servers can respond with the requested services. To accommodate a high volume of requests and the workloads resulting from those requests, groups of servers can be clustered together to act as a unified server to external clients. In this regard, in a load balancing configuration, any given request can be handled by any of a single or several servers, thereby improving scalability and fault-tolerance.

In load balancing workloads, the decision to route requests to different instances of a set of redundant resources, such as servers, server processes, or request processing logic, can involve a variety of request routing methodologies. In particular, selection methodologies can be selected in order to maximize throughput and minimize response latency. For instance, server load balancing oriented methodologies monitor server status and direct requests to lightly loaded servers. Notably, load balancing methodologies intend to distribute incoming workloads to achieve a strategic objective such as ensuring the high-availability of any one resource in a cluster to support subsequent incoming workload requests.

High availability depends not only upon proper load balancing of resources in a distributed computing arrangement, but also upon the proper operation of each resource in a cluster. The proper operation of a resource depends upon a number of factors including platform performance and the integrity of supporting logic. Platform performance can be constrained based upon processor speed and the amount of memory available for use by logic servicing a request. As most software developers can attest, however, memory availability can be particularly challenging irrespective of the distributed nature of an application.

Memory leakage, broadly defined, is the gradual loss of allocable memory due to the failure to de-allocate previously allocated, but no longer utilized memory. Typically, memory can be reserved for data having a brief lifespan. Once the lifespan has completed, the reserved memory ought to be returned to the pool of allocable memory so that the reserved memory can be used at a subsequent time as necessary. Importantly, where memory leakage persists without remediation, ultimately not enough memory will remain to accommodate the needs of other processes.

Recognizing the importance of addressing the memory leakage problem, computer programming language theorists have developed the notion of garbage collection. Garbage collection refers to the automated analysis of allocated memory to identify regions of allocated memory containing data which no longer are required for the operation of associated processes. In the context of object oriented programming languages such as the Java (TM) programming language, when objects residing in memory are no longer accessible within a corresponding application, the memory allocated to the “dead” object can be returned to the pool of allocable memory.

The process of garbage collection can be processor consumptive in nature. Consequently, the performance of a server experiencing garbage collection can suffer during the course of garbage collection. Yet, to external controllers such as load balancers, the operation of garbage collection is neither detected nor considered in the course of balancing loads among servers in a common cluster. As a result, even though a server in a cluster may appear available to the load balancer, assigning a load to a server experiencing load balancing can defeat the intended result of load balancing—namely high availability and optimal servicing of a workload.

### BRIEF SUMMARY OF THE INVENTION

Embodiments of the present invention address deficiencies of the art in respect to load balancing in an enterprise environment and provide a novel and non-obvious method, system and apparatus for garbage collection sensitive load balancing. In a first embodiment of the invention, a load balancing method can include selectively avoiding server resources experiencing garbage collection when routing workloads to server resources in a load balanced cluster of server resources. For example, selectively avoiding server resources experiencing garbage collection when routing workloads to server resources in a load balanced cluster of server resources, can include detecting a garbage collection operation in a particular server resource, and avoiding routing of a workload to the particular server resource until the garbage collection operation has completed.

In one aspect of the embodiment, detecting a garbage collection operation in a particular server resource can include receiving notification of imminent garbage collection in the particular server resource from a garbage collector for the particular server resource. Also, in another aspect of the embodiment, avoiding routing of a workload to the particular server resource until the garbage collection operation has completed can include identifying a backup server resource and routing the workload to the backup server resource in lieu of the particular server resource.

Finally, in yet another aspect of the embodiment, selectively avoiding server resources experiencing garbage collection when routing workloads to server resources in a load balanced cluster of server resources can include establishing a session for workload processing in a primary server resource and replicating the session to a backup server resource. An imminent garbage collection operation can be detected in the primary server resource, and a load balancer can be notified of the imminent garbage collection operation. Finally, subsequent workloads for the primary server resource can be processed in the backup server resource until the garbage collection operation has completed.

In another embodiment, a load balancing data processing system can be provided. The load balancing data processing system can include a load balancer and a selection of server resources coupled to the load balancer. Notably, garbage collectors each can be coupled to a corresponding one of the server resources. Finally, a garbage collection sensitive load balancing logic can be coupled to the load balancer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a distributed data processing system configured for garbage collection sensitive load balancing of workloads; and,

FIGS. 2A and 2B, taken together, are a flow chart illustrating a process for garbage collection sensitive load balancing of workloads.

### DETAILED DESCRIPTION OF THE INVENTION

Embodiments of the present invention provide a method, system and computer program product for garbage collection sensitive load balancing. In accordance with an embodiment of the present invention, a load balancer can selectively assign workloads to different servers in order to avoid assigning workloads to servers experiencing garbage collection. Specifically, the load balancer can detect garbage collection in each server and the load balancer can avoid assigning workloads to those servers until the garbage collection process has completed.

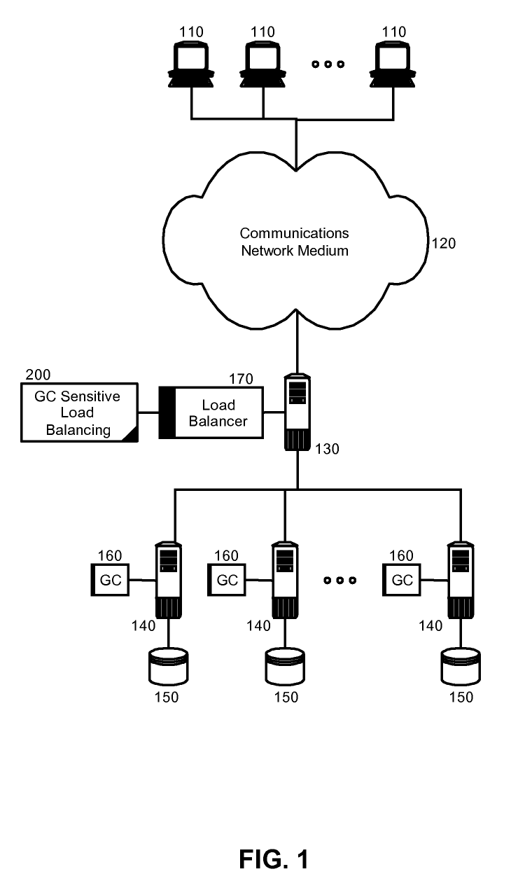

In further illustration, FIG. 1 is a schematic illustration of a distributed data processing system configured for garbage collection sensitive load balancing of workloads. The distributed data processing system can include one or more client computing devices 110 coupled to a cluster of server resources 140 over a computer communications medium 120 such as a data communications network. Each of the server resources 140 can include a physical computing platform having an operating system, or a virtual machine disposed within a physical computing platform. Moreover, each of the server resources 140 can be coupled to a workload routing platform 130 having a load balancer 170.

The load balancer 170 can be configured to receive service requests from the client computing devices 11O. The service requests can include requests for content or for processing and are referred generally herein as workloads. Upon receipt of a workload request, the load balancer 170 can assign the workload associated with the workload request to a selected one of the server resources 140 based upon any load balancing algorithm, such as selecting the least utilized one of the server resources 140. In this way, high availability can be achieved among the cluster of server resources 140.

Notably, each of the server resources 140 can include a data store 150 for storing workload data and a garbage collector 160 enabled to perform garbage collection on a corresponding one of the server resources 140 in order to avoid memory leakage. Garbage collection sensitive load balancing logic 200 can include program code enabled to detect a garbage collection operation in the server resources 140. Consequently, the program code of the garbage collection sensitive load balancing logic 200 can influence the routing of workloads to the server resources 140 in order to avoid assigning workloads to those of the server resources 140 experiencing garbage collection.

In one aspect of the invention, each garbage collector 160 can proactively notify the garbage collection sensitive load balancer 200 whenever a garbage collection operation is to be performed in a corresponding one of the server resources 140. Likewise, each garbage collector 160 can proactively notify the garbage collection sensitive load balancer 200 whenever a garbage collection operation has completed in a corresponding one of the server resources 140. As such, the garbage collection sensitive load balancer 200 can maintain an awareness of the garbage collection state of each of the server resources 140.

In another aspect of the invention, in anticipation of a garbage collection operation, a garbage collector 160 for a primary one of the server resources 140 can replicate either the entirety of an image of session data from a corresponding primary one of the data stores 150 to a backup one of the data stores 150 for a backup one of the server resources 140, or an incremental portion of an image of session data from a corresponding primary one of the data stores 150 to a backup one of the data stores 150 for a backup one of the server resources. In this way, during a garbage collection operation, the program code of the garbage collection sensitive load balancing logic 200 can route the workload to the backup one of the server resources 140 while maintaining continuity of a processing session from the primary one of the server resources 140. Once the garbage collection operation has completed in the primary one of the server resources 140, the image of the session data can be restored from the backup one of the data stores 150 to the primary one of the data stores 150.

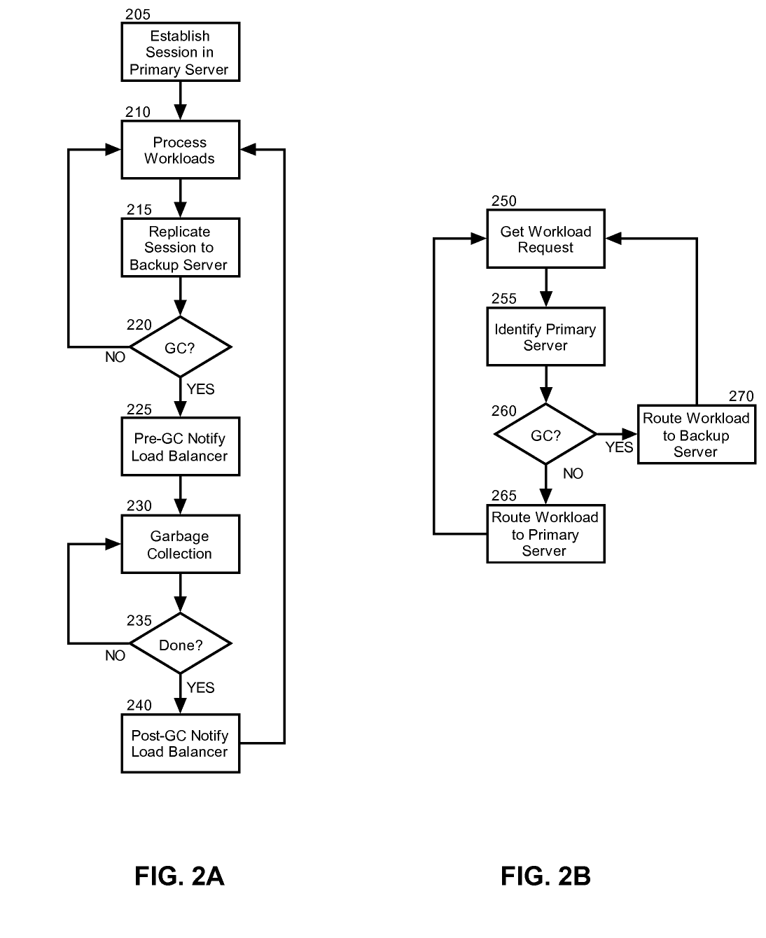

In more particular illustration of the latter aspect of the embodiment, FIGS. 2A and 2B, taken together, are a flow chart illustrating a process for garbage collection sensitive load balancing of workloads. First considering FIG. 2A, in block 205, a session can be established in a primary server and in block 210, workloads can be processed in the primary server in association with the session. In block 215, an image of the session can be replicated to a backup server. Thereafter, in decision block 220, if a garbage collection operation is imminent, in block 225, the primary server can notify the load balancer. In block 230, once the load balancer has been notified, the garbage collection process can commence. In decision block 235, if the garbage collection process has completed, in block 240, the load balancer can be notified of the completion of the garbage collection operation.

Turning now to FIG. 2B, in block 250, a workload request can be received in the load balancer for assignment to a server resource. In block 255, a primary server can be determined for the workload request. To the extent that a session already exists for the workload request, the primary server associated with the existing session can be identified. In decision block 260, it can be determined if a garbage collection operation has commenced in the primary server. If not, in block 265 the workload can be routed to the primary server. However, if it is determined that a garbage collection operation has commenced in the primary server, in block 270 the workload can be routed to the backup server. In consequence, server resources experiencing garbage collection can be avoided during load balancing only during the course of garbage collection. As such, the advantages of garbage collection and memory leak remediation can be attained without jeopardizing optimal load balancing in the enterprise environment.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A load balancing method comprising:
selectively avoiding server resources experiencing garbage collection when routing workloads to server resources in a load balanced cluster of server resources.

2. The method of claim 1, wherein selectively avoiding server resources experiencing garbage collection when routing workloads to server resources in a load balanced cluster of server resources, comprises:
detecting a garbage collection operation in a particular server resource; and, avoiding routing of a workload to the particular server resource until the garbage collection operation has completed.

3. The method of claim 2, wherein detecting a garbage collection operation in a particular server resource, comprises receiving notification of imminent garbage collection in the particular server resource from a garbage collector for the particular server resource.

4. The method of claim 2, wherein avoiding routing of a workload to the particular server resource until the garbage collection operation has completed, comprises:
identifying a backup server resource; and,
routing the workload to the backup server resource in lieu of the particular server resource.

5. The method of claim 1, wherein selectively avoiding server resources experiencing garbage collection when routing workloads to server resources in a load balanced cluster of server resources, comprises:
establishing a session for workload processing in a primary server resource;
replicating the session to a backup server resource;
detecting an imminent garbage collection operation in the primary server resource;
notifying a load balancer of the imminent garbage collection operation; and, processing subsequent workloads for the primary server resource in the backup server resource until the garbage collection operation has completed.

6. The method of claim 1, wherein selectively avoiding server resources experiencing garbage collection when routing workloads to server resources in a load balanced cluster of server resources, comprises:
establishing a session for workload processing in a primary server resource;
replicating an incremental portion of the session to a backup server resource;
detecting an imminent garbage collection operation in the primary server resource;
notifying a load balancer of the imminent garbage collection operation; and,
processing subsequent workloads for the primary server resource in the backup server resource until the garbage collection operation has completed.

7. A load balancing data processing system comprising:
a load balancer;
a plurality of server resources coupled to the load balancer;
a plurality of garbage collectors, each coupled to a corresponding one of the server resources; and,
garbage collection sensitive load balancing logic coupled to the load balancer.

8. A computer program product comprising a computer usable medium having computer usable program code for load balancing, the computer program product including:
computer usable program code for selectively avoiding server resources experiencing garbage collection when routing workloads to server resources in a load balanced cluster of server resources.

9. The computer program product of claim 8, wherein the computer usable program code for selectively avoiding server resources experiencing garbage collection when routing workloads to server resources in a load balanced cluster of server resources, comprises:
computer usable program code for detecting a garbage collection operation in a particular server resource; and,
computer usable program code for avoiding routing of a workload to the particular server resource until the garbage collection operation has completed.

10. The computer program product of claim 9, wherein the computer usable program code for detecting a garbage collection operation in a particular server resource, comprises computer usable program code for receiving notification of imminent garbage collection in the particular server resource from a garbage collector for the particular server resource.

11. The computer program product of claim 9, wherein the computer usable program code for avoiding routing of a workload to the particular server resource until the garbage collection operation has completed, comprises:
computer usable program code for identifying a backup server resource; and, computer usable program code for routing the workload to the backup server resource in lieu of the particular server resource.

12. The computer program product of claim 8, wherein the computer usable program code for selectively avoiding server resources experiencing garbage collection when routing workloads to server resources in a load balanced cluster of server resources, comprises:
computer usable program code for establishing a session for workload processing in a primary server resource;
computer usable program code for replicating the session to a backup server resource;
computer usable program code for detecting an imminent garbage collection operation in the primary server resource;
computer usable program code for notifying a load balancer of the imminent garbage collection operation; and,
computer usable program code for processing subsequent workloads for the primary server resource in the backup server resource until the garbage collection operation has completed.

13. The computer program product of claim 8, wherein the computer usable program code for selectively avoiding server resources experiencing garbage collection when routing workloads to server resources in a load balanced cluster of server resources, comprises:
computer usable program code for establishing a session for workload processing in a primary server resource;
computer usable program code for replicating an incremental portion of the session to a backup server resource; detecting an imminent garbage collection operation in the primary server resource;
computer usable program code for notifying a load balancer of the imminent garbage collection operation; and,
computer usable program code for processing subsequent workloads for the primary server resource in the backup server resource until the garbage collection operation has completed.
